(19) United States
(12) Patent Application Publication
(10) Pub. No.: US 2021/0102623 A1
(43) Pub. Date: Apr. 8, 2021

(54) AUTOMATIC TRANSMISSION CONTROL INTERFACE WITH TACTILE MANUAL GEAR SELECTION

(71) Applicant: Bernard Saletel, Rochester, MN (US)

(72) Inventor: Bernard Saletel, Rochester, MN (US)

(21) Appl. No.: 16/926,986

(22) Filed: Jul. 13, 2020

Related U.S. Application Data
(60) Provisional application No. 62/909,421, filed on Oct. 2, 2019.

(51) Int. Cl. F16H 59/02; F16H 59/04

(52) U.S. Cl. CPC F16H 59/0204; F16H 2059/081; F16H 2059/0252; F16H 59/044

(57) ABSTRACT

An automatic transmission control interface provides optional modes to operate gear selection via a tactile manual shift selector. The interface provides a dial selector able to select park, reverse, neutral, drive, and manual modes of the automatic transmission of the vehicle. When the dial selector is set to manual mode, a user may manually select a forward gear ratio using a tactile manual shifter mechanism having a traditional gateway mimicking that of a fully manual vehicle. However, unlike a fully manual shifter, no clutch operation is required, and no manual linkage exists between the shifter and the transmission. Instead, the shifter gateway has electronic switches engagable by the shifter which each correspond to a forward gear ratio. Engaging a switch causes a control unit to send a signal to the automatic transmission and engage a corresponding forward gear.

### CROSS-REFERENCE TO RELATED APPLICATION(S)

The present application is related to and claims priority to U.S. Provisional Patent Application No. 62/909,421 filed Oct. 2, 2019, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of automobiles of existing art and more specifically relates to a transmission control system.

### RELATED ART

While automatic transmission increasingly dominate the automobile industry due to their ease of use and reliability, manual transmissions continue to maintain desirability among automobile enthusiasts and drivers who wish to possess maximum control over their vehicle's operation and enjoy a more immersive driving experience. Recognizing this, many automobiles manufactures provide a hybridized solution, producing cars which mechanically and functionally feature an automatic transmission, but add an electronically operated manual mode which allows drivers to manually select gears.

Nonetheless, these manual gear modes can leave much to be desired. In one popular example, paddles are added to the steering wheel. Pressing the paddle upwardly selects a higher gear sequentially, and pressing the paddle downwardly selects a lower gear (or vice versa depending on model). Such a solution is not immersive. Additionally, users may lose track of which gear they are in, the paddle selection action not being specific to individual gears, and may need to glance at the dash to be reminded by the digital indicator. Other solutions, such as “+” and “−” keys on the selector, are equally lackluster. There is perceived a need for a manual gear selection system for automatic transmissions which improves the driving experience and also allows a driver to recognize which gear they are in by the specific action of engaging that gear.

U.S. Pat. No. 6,006,620 to Robert E. Lawrie et al. relates to an automated manual transmission controller. The described automated manual transmission controller includes a powertrain system for a hybrid vehicle. The hybrid vehicle includes a heat engine, such as a diesel engine, and an electric machine, which operates as both an electric motor and an alternator, to power the vehicle. The hybrid vehicle also includes a manual-style transmission configured to operate as an automatic transmission from the perspective of the driver. The engine and the electric machine drive an input shaft which in turn drives an output shaft of the transmission. In addition to driving the transmission, the electric machine regulates the speed of the input shaft in order to synchronize the input shaft during either an upshift or downshift of the transmission by either decreasing or increasing the speed of the input shaft.

### SUMMARY OF THE INVENTION

In view of the foregoing disadvantages inherent in the known transmission control system art, the present disclosure provides a novel automatic transmission control interface with tactile manual gear selection. The general purpose of the present disclosure, which will be described subsequently in greater detail, is to provide an automatic transmission control interface with tactile manual gear selection.

An automatic transmission control interface provides optional modes to operate gear selection via a tactile manual shift selector. The interface provides a dial selector able to select park, reverse, neutral, drive, and manual modes of the automatic transmission of the vehicle. When the dial selector is set to manual mode, a user may manually select a forward gear ratio using a tactile manual shifter mechanism having a traditional gateway mimicking that of a fully manual vehicle. However, unlike a fully manual shifter, no clutch operation is required, and no manual linkage exists between the shifter and the transmission. Instead, the shifter gateway has electronic switches engageable by the shifter which each correspond to a forward gear ration. Engaging a switch causes a control unit to send a signal to the automatic transmission and engage a corresponding forward gear.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, an automatic transmission control interface with tactile manual gear selection, constructed and operative according to the teachings of the present disclosure.

FIG. 1 is a perspective view of the automatic transmission control interface during an ‘in-use’ condition, according to an embodiment of the disclosure.

FIG. 2 is a diagram view of the automatic transmission control interface of FIG. 1, according to an embodiment of the present disclosure.

FIG. 3 is a cutaway view of the shifter of the automatic transmission control interface of FIG. 1, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a transmission control system and more particularly to an automatic transmission control interface with tactile manual gear selection as used to improve the ease of use of manual gear selection in an automatic-transmission vehicle.

The disclosed automatic transmission control interface provides vehicles with a multifunctional gear shifting system capable of being operated via automatic gear shifting or manual shifting. This allows drivers to operate the manual transmission to shift gears without having to apply a clutch. A user manually upshifts or downshifts the transmission via a center console shift lever with the same pattern as a clutched standard shift pattern. This system functions as a modernization of the four-speed (five-speed, six-speed, etc.) manual transmission used in sports cars and sedans. It utilizes a rotary switched to put the car in park or drive for complete automatic operation or manual to use the floor shift through gears. The rotary switch mounted on the dash can be used to swap a vehicle between manual or automatic gear shifting. The rotary switch may be mounted on the dash. The manual transmission can function as a center console shift lever with the same pattern as a clutched standard shift pattern. This system can be integrated as a modernization of the four-speed manual transmission used in sports cars and sedans. Users can operate either transmission operation mode as desired for driving the vehicle. Without the clutch, the manual transmission can function as normal and still offer a unique method of operating the vehicle. Exact size, measurement, construction, and design specifications may vary upon further development and manufacturing.

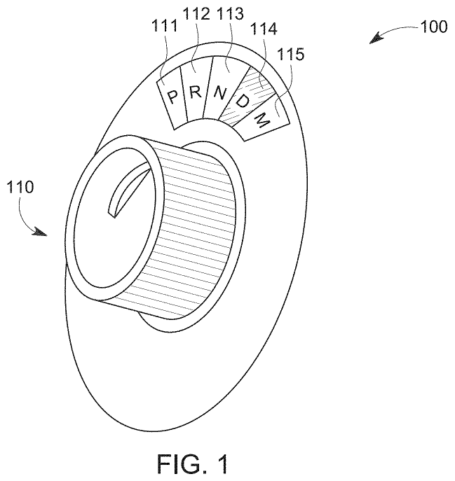

Referring now more specifically to the drawings by numerals of reference, there is shown in FIGS. 1-3, various views of a control interface 100.

FIG. 1 shows a control interface during an ‘in-use’ condition, according to an embodiment of the present disclosure. Here, the control interface may be beneficial for use by a user to control the operation of an automatic transmission in an automobile. The automatic transmission control interface 100 is able to control and operate an automatic transmission 10 having multiple forward gear ratios and a reverse gear ratio. As shown, automatic transmission control interface 100 may comprise dial selector 110 enabling a user to select vehicle drive modes. Dial selector 110 may be a tactile and engageable rotary switch mounted on a dash of a vehicle comprising park-position 111, reverse-position 112, neutral-position 113, drive-position 114, and manual gear mode-position 115.

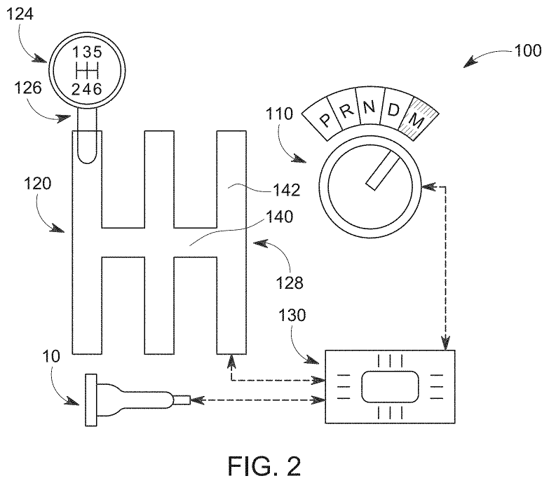

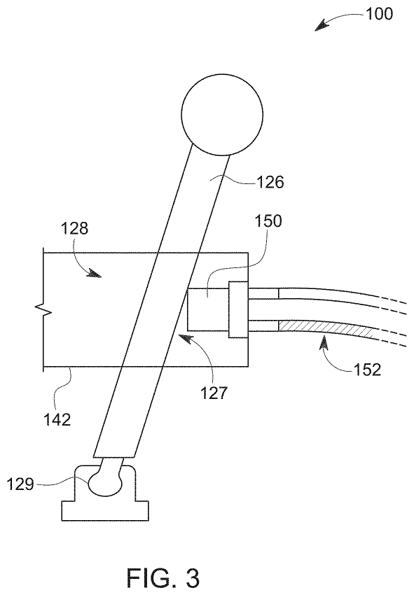

FIG. 2 shows the control interface of FIG. 1, according to an embodiment of the present disclosure. Gear selector 120 comprises positions for each forward gear ratio. Gear selector 120 comprises shifter-pathway 128, which itself includes neutral gateway 140 and plurality of slots 142 branching from neutral gateway 140. Each of plurality of slots 142 may correspond to a forward gear ratio and may each terminate in electrical contact 150 (FIG. 3). In one exemplary embodiment, electrical contact 150 (FIG. 3) is a self-contained mechanical switch which is engageable by shift-lever 126 as shift-lever 126 is navigated through shifter-pathway 128. Shift-lever 126 may terminate in shift-knob 124 to enable a user to easily manipulate gear selector 120. Gear selector 120 may only be able to send a signal to processor 130 when dial selector 110 is set to manual gear mode-position 115 (FIG. 1).

Processor 130 may be able to receive signals from gear selector 120 indicating a selected of the positions corresponding to one of the forward gear ratios when dial selector 110 is set to manual gear mode. Subsequently, processor 130 is able to send out signals to automatic transmission 10 to engage the selected forward gear ratio.

FIG. 3 is a cutaway view of the automatic transmission control interface of FIG. 1, according to an embodiment of the present disclosure. Shift-lever 126 may be able to navigate neutral gateway 140 and plurality of slots 142 when hand-manipulated by a user. As illustrated, shift-lever 126 may be pivotably mounted to the vehicle beneath shifter-pathway 128 by mount 129. Shift-lever 126 having an engager able to engage electrical contact 150 corresponding to one of plurality of slots 142 of shifter-pathway 128, such that engaging electrical contact 150 sends a signal to processor 130 (FIG. 2) indicating a selected one of the positions corresponding to one of the forward gear ratios when dial selector 110 (FIG. 1) is set to manual gear mode. Such a signal may be communicated by circuitry 152 joining each one of electrical contacts 150 to processor 130 (FIG. 2). Engager 127 may be a protrusion of shift-lever 126, or may simply be the continuous lateral side of shift-lever 126 as it impinges upon electrical contact 150. When none of electrical contacts 150 are engaged by engager 127, processor 130 receives no signal and maintains automatic transmission 10 (FIG. 2) in neutral when dial selector 110 (FIG. 2) is set to manual gear mode. Processor 130 (FIG. 2) may, in some embodiments, be a computing mechanism able to send a neutral-signal to the transmission instructing the transmission not to engage any forward gear when none of electrical contacts 150 are engaged by engager 127. Each electrical contact may be a normally-opened switch. Engager 127 may be a mechanical device able to press the normally-opened switch when shift-lever 126 is fully inserted into the corresponding one of plurality of slots 142 by the user. In alternative embodiments, electrical contact 150 and engager 127 may each comprise supplementary contacts of a switch which, when engaged, complete a gear-circuit indicating to processor 130 that the corresponding one of the forward gear ratios is to be selected.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. An automatic transmission control interface for operating an automatic transmission having multiple forward gear ratios and a reverse gear ratio, the automatic transmission control interface comprising:
a dial selector comprising positions engaging
park,
reverse,
drive, and
manual gear mode;
a gear selector comprising positions for each forward gear ratio; and
a processor able to
receive signals from the gear selector indicating a selected of the positions corresponding to one of the forward gear ratios when the dial selector is set to manual gear mode, and
out signals to the automatic transmission to engage the selected forward gear ratio.

2. The automatic transmission control interface of claim 1, wherein the gear selector comprises
a shifter-pathway having
a neutral gateway,
a plurality of slots branching from the neutral gateway, each of the plurality of slots corresponding to a forward gear ratio, each of the plurality of slots terminating in an electrical contact; and
a shift-lever able to navigate the neutral gateway and the plurality of slots when hand-manipulated by a user, the shift-lever having an engager able to engage the electrical contact corresponding to one of the plurality of slots, such that engaging the electrical contact sends a signal to the processor indicating a selected of the positions corresponding to one of the forward gear ratios when the dial selector is set to manual gear mode.

3. The automatic transmission control interface of claim 2, wherein when none of the electrical contacts are engaged by the engager, the processor receives no signal and maintains the automatic transmission in neutral when the dial selector is set to manual gear mode.

4. The automatic transmission control interface of claim 2, wherein the processor comprises a computer able to
send a neutral-signal to the transmission instructing the transmission not to engage any forward gear when none of the electrical contacts are engaged by the engager.

5. The automatic transmission control interface of claim 2, wherein
each electrical contact is a normally-opened switch, and
the engager is a mechanical device able to press the normally-opened switch when the shift-lever is fully inserted into the corresponding one of the plurality of slots by the user.

6. The automatic transmission control interface of claim 1, wherein the electrical contact and the engager each comprises supplementary contacts of a switch which, when engaged, complete a gear-circuit indicating to the circuit that the corresponding one of the forward gear ratios is to be selected.

7. An automatic transmission control interface for operating an automatic transmission having multiple forward gear ratios and a reverse gear ratio, the automatic transmission control interface comprising:
a dial selector comprising positions engaging
park,
reverse,
drive, and
manual gear mode;
a gear selector comprising positions for each forward gear ratio; and
a processor able to
receive signals from the gear selector indicating a selected of the positions corresponding to one of the forward gear ratios when the dial selector is set to manual gear mode, and
out signals to the automatic transmission to engage the selected forward gear ratio.
wherein the gear selector further comprises a shifter-pathway having
a neutral gateway,
a plurality of slots branching from the neutral gateway, each of the plurality of slots corresponding to a forward gear ratio, each of the plurality of slots terminating in an electrical contact; and
a shift-lever able to navigate the neutral gateway and the plurality of slots when hand-manipulated by a user, the shift-lever having an engager able to engage the electrical contact corresponding to one of the plurality of slots, such that engaging the electrical contact sends a signal to the processor indicating a selected of the positions corresponding to one of the forward gear ratios when the dial selector is set to manual gear mode;
wherein when none of the electrical contacts are engaged by the engager, the processor receives no signal and maintains the automatic transmission in neutral when the dial selector is set to manual gear mode;
wherein the processor comprises a computer able to send a neutral-signal to the transmission instructing the transmission not to engage any forward gear when none of the electrical contacts are engaged by the engager;
wherein each electrical contact is a normally-opened switch; and
wherein the engager is a mechanical device able to press the normally-opened switch when the shift-lever is fully inserted into the corresponding one of the plurality of slots by the user.
